(19) United States
(12) Patent Application Publication
(10) Pub. No.: US 2026/0266205 A1
(43) Pub. Date: Sep. 10, 2026

(54) DISCHARGE APPARATUS

(71) Applicant: ISUZU MOTORS LIMITED, Yokohama-shi (JP)

(72) Inventor: Takeshi OKAMOTO, Fujisawa-shi (JP)

(21) Appl. No.: 19/457,620

(22) Filed: Jan. 23, 2026

(30) Foreign Application Priority Data
Mar. 6, 2025 (JP) 2025-035570

(51) Int. Cl. F01M 1/16; F01M 11/00; F02B 43/10

(52) U.S. Cl. CPC F01M 1/16; F01M 11/0004; F02B 43/10; F01M 2250/00; F02B 2043/103

(57) ABSTRACT

A discharge apparatus has: an oil pan that retains a lubricant for lubricating an engine that combusts a combustible gas; a conduit connected to a bottom section of the oil pan; a pump that is provided in the conduit and discharges, from the oil pan, liquid containing at least one of the lubricant and water in the oil pan before activation of the engine; a sensor that is provided in the conduit and measures at least one of a value of transmittance and a value of reflectance of the liquid flowing through the conduit; and a pump control section that stops discharge of the liquid by stopping the pump when the measurement value of the sensor has exceeded a threshold.

### CROSS-REFERENCE TO RELATED APPLICATIONS

The present application claims priority to Japanese Patent Applications No. 2025-35570, filed on Mar. 6, 2025, contents of which are incorporated herein by reference in their entirety.

### BACKGROUND OF THE INVENTION

The present invention relates to a discharge apparatus that discharges water mixed in a lubricant. Water is mixed in a lubricant for lubricating an engine, in some cases. Japanese Patent Application Publication No. H5-171913 discloses a technology for discharging a lubricant in which water is mixed, when water is mixed in the lubricant.

In the technology disclosed in Japanese Patent Application Publication No. H5-171913, the lubricant in which water is mixed is discharged, and accordingly the lubricant also is discharged together with water, undesirably. Because of this, there is a problem that the amount of the discharged lubricant increases, undesirably.

### BRIEF SUMMARY OF THE INVENTION

The present invention has been made in view of these matters, and an object thereof is to reduce the amount of a lubricant to be discharged when water mixed in the lubricant is discharged.

An aspect of the present invention provides a discharge apparatus having: a liquid retaining section that retains a lubricant for lubricating an engine that combusts a combustible gas; a conduit connected to a bottom section of the liquid retaining section; a pump that is provided in the conduit and discharges, from the liquid retaining section, liquid containing at least one of the lubricant and water in the liquid retaining section before activation of the engine; a sensor that is provided in the conduit and measures at least one of a value of transmittance and a value of reflectance of the liquid flowing through the conduit; and a control section that stops discharge of the liquid by stopping the pump when the value measured by the sensor has exceeded a threshold.

### BRIEF DESCRIPTION OF THE DRAWINGS

FIG. 1 is a drawing for explaining the configuration of a discharge apparatus.

FIG. 2 is a drawing for explaining the configuration of a sensor.

FIG. 3 is a drawing for explaining changes in a measurement value.

FIG. 4 is a flowchart illustrating the procedure of a process of discharging water.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### Configuration of Discharge Apparatus 200

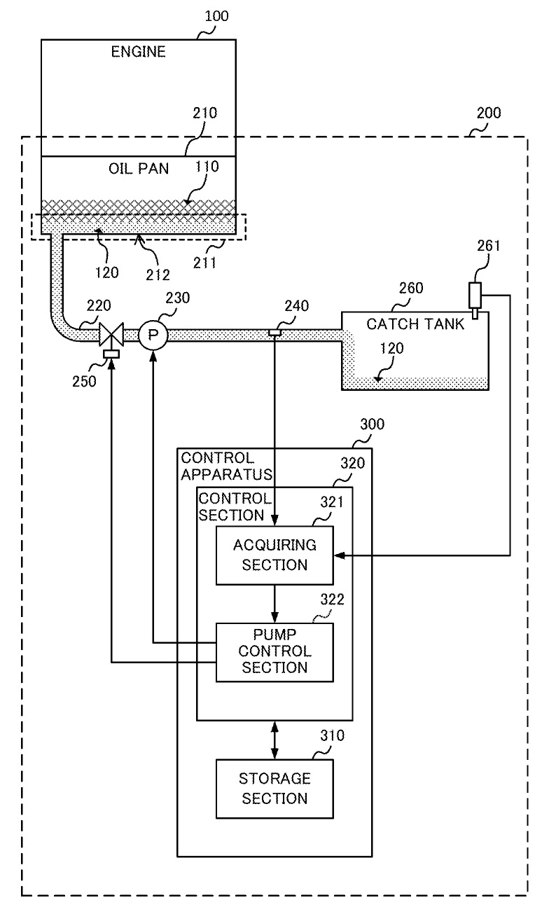

FIG. 1 is a drawing for explaining the configuration of a discharge apparatus 200. The discharge apparatus 200 is an apparatus for discharging water mixed in a lubricant 110 for lubricating an engine 100 from an oil pan 210 that retains the lubricant 110. The discharge apparatus 200 includes the oil pan 210, a conduit 220, a pump 230, a sensor 240, a valve 250, a catch tank 260, a water level gauge 261, and a control apparatus 300.

For example, whereas the engine 100 is mounted on a vehicle or a ship, the engine 100 may be installed at a facility or the like. The engine 100 combusts a combustible gas and generates motive power. For example, the combustible gas is hydrogen or a natural gas. The natural gas is a gas containing hydrocarbons such as methane, ethane, and propane. The amount of water that is generated when hydrogen or the combustible gas is combusted is greater than the amount of water that is generated when gasoline or diesel fuel is combusted. Accordingly, in the engine 100 that combusts hydrogen or the combustible gas, water is more likely to be mixed in the lubricant 110 than in an engine that combusts gasoline or diesel fuel. It is assumed in the following explanation that the engine 100 in the present embodiment combusts hydrogen.

The oil pan 210 is a liquid retaining section that retains the lubricant 110 for lubricating the engine 100. The lubricant 110 retained in the oil pan 210 lubricates the engine 100 during the operation of the engine 100 while circulating through a conduit (not illustrated) passing through the engine 100. The lubricant 110 lubricates the engine 100 and then falls from the engine 100. The oil pan 210 is provided below the engine 100 and retains the lubricant 110 having fallen from the engine 100. Not only the lubricant 110, but also water generated during the combustion of hydrogen falls into the oil pan 210. Accordingly, the oil pan 210 retains the lubricant 110 in which water generated during the combustion of hydrogen is mixed.

The conduit 220 is connected to a bottom section 211 of the oil pan 210. Specifically, the conduit 220 is connected to a bottom surface 212 of the bottom section 211.

The pump 230 is provided in the conduit 220. The pump 230 discharges liquid 120 in the oil pan 210 from the oil pan 210. The liquid 120 contains at least one of the lubricant 110 and water. The pump 230 discharges, from the oil pan 210, the liquid 120 retained at the bottom section 211 of the oil pan 210 before the activation of the engine 100. The pump 230 is a centrifugal pump or an axial flow pump, but is not limited to these.

The sensor 240 is provided downstream of the pump 230 in the conduit 220. The sensor 240 may be provided upstream of the pump 230 in the conduit 220. The sensor 240 is provided at a position in the conduit 220 where the conduit 220 is covered with the liquid 120. For example, the sensor 240 is provided at a position where the conduit 220 is horizontal. The sensor 240 is provided inside the conduit 220. Specifically, the sensor 240 is attached on the wall surface of the conduit 220 inside the conduit 220. In other words, the sensor 240 is provided on the inner wall surface of the conduit 220. The sensor 240 measures at least one of a value of transmittance and a value of reflectance of the liquid 120 flowing through the conduit 220. The sensor 240 in the present embodiment measures the reflectance of the liquid 120.

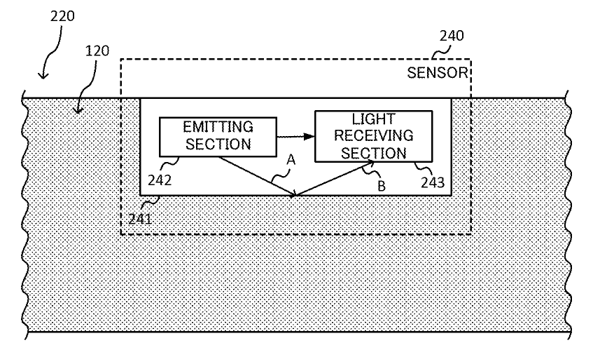

FIG. 2 is a drawing for explaining the configuration of the sensor 240. The sensor 240 has a case 241, an emitting section 242, and a light receiving section 243. The case 241 prevents the emitting section 242 and the light receiving section 243 from contacting the liquid 120. In other words, the emitting section 242 and the light receiving section 243 are provided in the case 241 such that the emitting section 242 and the light receiving section 243 do not directly contact the liquid 120. The case 241 is made of a transparent substance. For example, the case 241 is made of glass or transparent plastic, but is not limited to these.

The emitting section 242 emits light A to the liquid 120 flowing through the conduit 220. For example, the emitting section 242 emits a visible ray to the liquid 120, but may emit an infrared ray or a ultraviolet ray to the liquid 120. The light receiving section 243 is provided adjacent to the emitting section 242. The light receiving section 243 receives the light A emitted from the emitting section 242. Specifically, the light receiving section 243 receives reflection light B that is produced when the light A is reflected by the liquid 120. The light receiving section 243 notifies the control apparatus 300 of the value of the ratio (reflectance) of the intensity of the reflection light B to the intensity of the light A emitted by the emitting section 242. Hereinbelow, the value measured by the sensor 240 is referred to as a measurement value. Whereas the sensor 240 according to the embodiment measures the reflectance of the liquid 120 as described above, the sensor 240 may have the emitting section 242 and the light receiving section 243 provided on the side opposite to the emitting section 242 with the liquid 120 being interposed therebetween and measure the transmittance of the liquid 120. Note that a sensor using any known technology can be used as the sensor 240 as long as the sensor can measure reflectance or transmittance.

The detection sensitivity of the sensor 240 is set as appropriate. For example, the detection sensitivity of the sensor 240 is set such that a detected value in a case in which the liquid 120 contains only the lubricant 110 is greater than a detected value in a case in which the liquid 120 contains only water. The sensitivity of the sensor 240 is set such that the sensor 240 outputs a measurement value of [100] when the liquid 120 flowing through the conduit 220 contains only the lubricant 110 and outputs a measurement value of when the liquid 120 flowing through the conduit 220 contains only the water. When the liquid 120 contains both the lubricant 110 and water, the sensor 240 outputs a measurement value that decreases as the ratio of the lubricant 110 to the liquid 120 lowers.

The valve 250 is provided upstream of the pump 230 in the conduit 220. The valve 250 selectively establishes or interrupts communication between the oil pan 210 and the pump 230. When the valve 250 is in an opened state, communication between the oil pan 210 and the pump 230 is established. When the valve 250 is in a closed state, communication between the oil pan 210 and the pump 230 is interrupted.

The catch tank 260 is provided downstream of the pump 230 in the conduit 220. Specifically, the catch tank 260 is connected to a portion on the downstream side of the sensor 240 in the conduit 220. The conduit 220 is connected to the catch tank 260 at an upper section of the catch tank 260. Specifically, the conduit 220 is connected to the catch tank 260 at an upper section of the side surface of the catch tank 260. More specifically, the conduit 220 is connected to the catch tank 260 at the upper half obtained by vertically dividing the side surface of the catch tank 260 into two halves. The catch tank 260 retains the liquid 120 that has been discharged from the oil pan 210 and has passed through the conduit 220.

The water level gauge 261 measures the amount of the liquid 120 retained in the catch tank 260. The water level gauge 261 measures the amount of the liquid 120 on the basis of the distance between the water level gauge 261 and the liquid surface of the liquid 120, the height of the catch tank 260, and the bottom area of the catch tank 260. The height of the catch tank 260 is the length from the bottom surface to the upper surface of the catch tank 260 in the vertical direction. Specifically, the amount of the liquid 120 retained in the catch tank 260 is measured by substituting the respective values into [bottom area of catch tank 260 × (height of catch tank 260 – distance to liquid surface)]. Note that it is assumed that the bottom area and height of the catch tank 260 are stored in a storage section of the water level gauge 261.

The control apparatus 300 has a storage section 310 and a control section 320. The storage section 310 is a storage medium including a ROM (Read Only Memory), a RAM (Random Access Memory), a hard disk, and the like. The storage section 310 stores programs to be executed by the control section 320.

For example, the control section 320 is a computational resource including a processor such as a CPU (Central Processing Unit). By executing a program stored in the storage section 310, the control section 320 enables functions as an acquiring section 321 and a pump control section 322.

The acquiring section 321 acquires a measurement value of the sensor 240. The acquiring section 321 acquires the reflectance measured by the sensor 240 each time the sensor 240 acquire the reflectance of the liquid 120. In addition, the acquiring section 321 acquires the amount of the liquid 120 measured by the water level gauge 261.

The pump control section 322 is a control section that controls the operation of the pump 230. By activating the pump 230, the pump control section 322 discharges the liquid 120 retained at the bottom section 211 of the oil pan 210 from the oil pan 210.

Meanwhile, since the specific gravity of water is greater than the specific gravity of the lubricant 110, water mixed in the lubricant 110 moves in the vertically downward direction through the lubricant 110 over time. That is, when a certain amount of time has passed since the engine 100 has been stopped, water mixed in the lubricant 110 separates from the lubricant 110 and is retained at the bottom section 211 of the oil pan 210. In other words, the lubricant 110 and water separate from each other after a predetermined length of time has passed since the engine 100 has been stopped, and this results in a state where only water is contained in the liquid 120 retained at the bottom section 211 of the oil pan 210.

In view of this, by activating the pump 230 in a state where only water is contained in the liquid 120 retained at the bottom section 211 of the oil pan 210, the pump control section 322 discharges water retained at the bottom section 211 of the oil pan 210. For example, when a starter switch for activating the engine 100 is turned on after the predetermined length of time has passed since the last time the engine 100 has been stopped, the pump control section 322 activates the pump 230. The predetermined length of time is a length of time which is required for water to separate from the lubricant 110 and be retained at the bottom section 211 of the oil pan 210. For example, a specific value of the predetermined length of time is eight hours, but is not limited to this. When the length of time that has passed from the last time the engine 100 has been stopped to the current time is equal to or longer than the predetermined length of time, the pump control section 322 opens the valve 250 in response to the starter switch being turned on. The pump control section 322 opens the valve 250 and then activates the pump 230. When the pump 230 is activated, water retained at the bottom section 211 of the oil pan 210 is discharged from the oil pan 210.

In this manner, when there is a high likelihood that only water is retained at the bottom section 211 of the oil pan 210 after the predetermined length of time has passed since the last time the engine 100 has been stopped, the pump control section 322 activates the pump 230. Thereby, the pump control section 322 can discharge only water having separated from the lubricant 110 and retained at the bottom section 211 of the oil pan 210.

Meanwhile, when the engine 100 is activated, the lubricant 110 is supplied to the engine 100 by circulating through an unillustrated conduit. At this time, since water retained in the oil pan 210 also circulates through the conduit together with the lubricant 110, water having separated from the lubricant 110 mixes into the lubricant 110. In view of this, the pump control section 322 activates the pump 230 before activating the engine 100. Specifically, the pump control section 322 opens the valve 250 in response to the starter switch being turned on and activates the pump 230 after opening the valve 250 and before activating the engine 100. In this manner, by discharging water retained at the bottom section 211 of the oil pan 210 before the activation of the engine 100, the pump control section 322 can prevent water in the oil pan 210 from undesirably being mixed in the lubricant 110 again.

When the predetermined length of time has not passed since the last time the engine 100 has been stopped, the pump control section 322 does not activate the pump 230. Specifically, when the starter switch is turned on, and the predetermined length of time has not passed since the last time the engine 100 has been stopped, the pump control section 322 activates the engine 100 without activating the pump 230. The pump control section 322 activates the engine 100 by transmitting an instruction for activating the engine 100 to an engine control apparatus that controls the engine 100. By doing so, the pump control section 322 can promptly activate the engine 100 without activating the pump 230 when there is a low likelihood that only water is retained at the bottom section 211 of the oil pan 210.

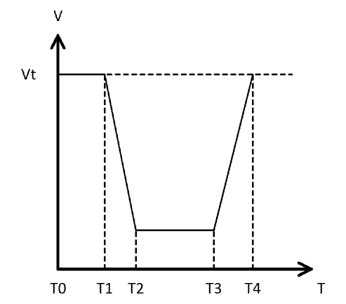

When the pump 230 is activated, the liquid 120 discharged from the bottom section 211 of the oil pan 210 flows through the conduit 220. The reflectance of the liquid 120 flowing through the conduit 220 is measured by the sensor 240. FIG. 3 is a drawing for explaining changes in the measurement value. At time T0, the starter switch of the vehicle is turned on, and the pump 230 is activated. The measurement value from time T0 to time T1 represents the reflectance of the lubricant 110. This is because the lubricant 110 discharged from the oil pan 210 last time is remaining in the conduit 220.

From time T0 to time T1, the pump control section 322 causes the pump 230 to operate. Specifically, the pump control section 322 causes the pump 230 to keep operating until waiting time passes since the pump 230 has been activated. The waiting time is a length of time required for the lubricant 110 remaining in the conduit 220 to be discharged to allow the sensor 240 to start measuring the reflectance of water. It is sufficient if a specific value of the waiting time is determined as appropriate through experiments and the like. The specific value is two seconds, for example, but is not limited to this.

At time T1, the lubricant 110 having remained near the sensor 240 in the conduit 220 starts being pushed out by water having been retained at the bottom section 211. From time T1 to time T2, the ratio of water to the liquid 120 increases, and accordingly the measurement value lowers. At time T2, the whole of the liquid 120 flowing near the sensor 240 in the conduit 220 becomes water. From time T2 to time T3, the reflectance of water is measured.

At time T3, the lubricant 110 starts being mixed in the liquid 120 discharged from the oil pan 210. From time T3 to time T4, the ratio of the lubricant 110 to the liquid 120 increases, and accordingly the measurement value increases. At time T4, the whole of the liquid 120 flowing near the sensor 240 in the conduit 220 becomes the lubricant 110.

The pump control section 322 stops the pump 230 in response to the whole of the liquid 120 flowing near the sensor 240 in the conduit 220 becoming the lubricant 110. For example, when the measurement value of the sensor 240 has exceeded a threshold Vt, the pump control section 322 stops the pump 230. Specifically, the pump control section 322 stops the pump 230 when the measurement value measured by the sensor 240 has exceeded the threshold Vt after the waiting time has passed. The threshold Vt is determined on the basis of the reflectance of the lubricant 110. The threshold Vt is smaller than the measurement value [100] in a case in which the liquid 120 contains only the lubricant 110 and is greater than the measurement value [20] in a case in which the liquid 120 contains only water. A specific value of the threshold Vt is 80. The pump control section 322 stops the pump 230 and then stops discharge of the liquid 120 from the oil pan 210 by closing the valve 250. By doing so, the pump control section 322 appropriately discharges water from the oil pan 210 and at the same time can prevent the lubricant 110 from being discharged from the oil pan 210.

The pump control section 322 closes the valve 250 and then activates the engine 100. Specifically, the pump control section 322 transmits an instruction for activating the engine 100 to the engine control apparatus. Thereby, the pump control section 322 can activate the engine 100 in a state where water is not mixed in the lubricant 110.

The liquid 120 discharged from the oil pan 210 is retained in the catch tank 260. When the amount of the liquid 120 retained in the catch tank 260 has become equal to or greater than a predetermined amount, the pump control section 322 notifies that the amount of the liquid 120 is equal to or greater than the predetermined amount. The predetermined amount is determined in accordance with the retainable capacity of the catch tank 260. A specific value of the predetermined amount is 80% the maximum capacity of the catch tank 260, but is not limited to this. Specifically, the pump control section 322 acquires the amount of the liquid 120 retained in the catch tank 260 from the water level gauge 261, and when the acquired amount of the liquid 120 has become equal to or greater than the predetermined amount, notifies that the amount of the liquid 120 retained in the catch tank 260 is equal to or greater than the predetermined amount. For example, the pump control section 322 notifies that the amount of the liquid 120 is equal to or greater than the predetermined amount by turning on a lamp mounted on the vehicle. The pump control section 322 may notify that the amount of the liquid 120 is equal to or greater than the predetermined amount by causing a speaker to output sound representing that the amount of the liquid 120 is equal to or greater than the predetermined amount or by causing a display to display information representing that the amount of the liquid 120 is equal to or greater than the predetermined amount.

The pump control section 322 can notify, for example, an administrator of the vehicle that the catch tank 260 will no longer be able to retain the liquid 120 in the near future by notifying that the amount of the liquid 120 has become equal to or greater than the predetermined amount. As a result, it becomes possible for the administrator to discard the liquid 120 retained in the catch tank 260 or replace the catch tank 260 with a new catch tank 260 before the catch tank 260 is no longer able to retain the liquid 120. That is, the pump control section 322 can make it easier for the administrator to perform work.

### Process of Discharging Water

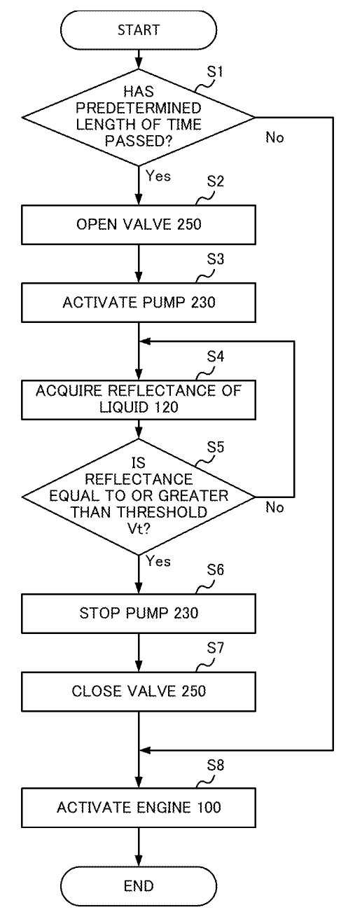

FIG. 4 is a flowchart illustrating the procedure of a process of discharging water. The process of discharging water is executed at a timing when the starter switch for activating the engine 100 is turned on.

The pump control section 322 determines whether or not the predetermined length of time has passed since the last time the engine 100 has been stopped (Step S1). When the predetermined length of time has passed (Yes at Step S1), the pump control section 322 opens the valve 250 (Step S2). The pump control section 322 opens the valve 250 and then activates the pump 230 (Step S3).

The acquiring section 321 acquires the reflectance of the liquid 120 as the measurement value of the sensor 240 (Step S4). Specifically, the acquiring section 321 acquires the reflectance of the liquid 120 measured after the waiting time has passed since the pump 230 has been activated. The pump control section 322 determines whether or not the reflectance is equal to or higher than the threshold Vt (Step S5). When the reflectance is lower than the threshold (No at Step S5), the pump control section 322 waits until reflectance which is equal to or higher than the threshold Vt is acquired. When the reflectance is equal to or higher than the threshold Vt (Yes at Step S5), the pump control section 322 stops the pump 230 (Step S6). The pump control section 322 stops the pump 230 and then closes the valve 250 (Step S7).

The pump control section 322 closes the valve 250 and then activates the engine 100 (Step S8). In addition, when the predetermined length of time has not passed since the last time the engine 100 has been stopped (No at Step S1), the pump control section 322 execute Step 8, that is, activates the engine 100, without executing the processes from Step S2 to Step S7.

### Modification Examples

The conduit 220 according to the embodiment is connected to the bottom surface 212 of the bottom section 211 of the oil pan 210. However, the conduit 220 is not limited to this. The conduit 220 may be disposed in any manner as long as the liquid 120 retained at the bottom section 211 of the oil pan 210 can be discharged from the oil pan 210. For example, the conduit 220 may be inserted into the oil pan 210 from above the oil pan 210. In this case, the liquid 120 retained at the bottom section 211 of the oil pan 210 is discharged from the oil pan 210 by being suctioned from the conduit 220.

### Effects of Discharge Apparatus 200

As explained above, the discharge apparatus 200 has: the pump 230 that is provided in the conduit 220 connected to the bottom section 211 of the oil pan 210 that retains the lubricant 110 for lubricating the engine 100 that combusts a combustible gas and discharges, from the oil pan 210, the liquid 120 containing at least one of the lubricant 110 and water in the oil pan 210 before the activation of the engine 100; the sensor 240 that is provided in the conduit 220 and measures at least one of a value of transmittance and a value of the reflectance of the liquid 120 flowing through the conduit 220; and the pump control section 322 that stops discharge of the liquid by stopping the pump 230 when the measurement value of the sensor 240 has exceeded the threshold Vt.

Water mixed in the lubricant 110 has specific gravity greater than the specific gravity of the lubricant 110. Accordingly, water mixed in the lubricant 110 separates from the lubricant 110 while the engine 100 is stopped and is retained at the bottom section 211 of the oil pan 210 that retains the lubricant 110. In other words, water or the liquid 120 containing a lot of water is retained at the bottom section 211 of the oil pan 210. By discharging the liquid 120 retained at the bottom section 211 of the oil pan 210 before the activation of the engine 100, the discharge apparatus 200 can discharge water retained at the oil pan 210 from the oil pan 210.

Then, since the transmittance and reflectance of water and the transmittance and reflectance of the lubricant 110 are different, when at least one of the transmittance and reflectance of the liquid 120 discharged from the oil pan 210 has become equal to or greater than a threshold, it can be determined that the discharged liquid 120 having been water has become the lubricant 110. When the transmittance or reflectance of the liquid 120 discharged from the oil pan 210 has become equal to or greater than the threshold, the discharge apparatus 200 stops discharge of the liquid 120. Thereby, the discharge apparatus 200 can discharge water retained in the bottom section 211 when discharging water mixed in the lubricant 110, and accordingly can reduce the amount of the lubricant 110 discharged from the oil pan 210.

Whereas the present invention has been explained using an embodiment thus far, the technical scope of the present invention is not limited by the scope described in the embodiment described above, but various modifications and changes are possible within the scope of a gist of the present invention. For example, all or some of apparatuses can be configured in a functionally or physically distributed or integrated manner in any units. In addition, new embodiments that are generated by any combination of a plurality of embodiments are also included in embodiments of the present invention. Effects of the new embodiments generated by the combination combine effects of the original embodiments.

What is claimed is:

1. A discharge apparatus comprising:
a liquid retaining section that retains a lubricant for lubricating an engine that combusts a combustible gas;
a conduit connected to a bottom section of the liquid retaining section;
a pump that is provided in the conduit and discharges, from the liquid retaining section, liquid containing at least one of the lubricant and water in the liquid retaining section before activation of the engine;
a sensor that is provided in the conduit and measures at least one of a value of transmittance and a value of reflectance of the liquid flowing through the conduit; and
a control section that stops discharge of the liquid by stopping the pump when the value measured by the sensor has exceeded a threshold.

2. The discharge apparatus according to claim 1, wherein
when a predetermined length of time has passed since the engine has been stopped, the control section causes the pump to discharge the liquid by activating the pump before activation of the engine.

3. The discharge apparatus according to claim 2, wherein
when the predetermined length of time has not passed since the engine has been stopped, the control section activates the engine without activating the pump.

4. The discharge apparatus according to claim 1, wherein
the control section activates the pump after a starter switch for activating the engine has been turned on and before the engine is activated.

5. The discharge apparatus according to claim 1, wherein
when the measured value has exceeded the threshold after predetermined waiting time has passed since the pump has been activated, the control section stops the pump.

6. The discharge apparatus according to claim 1, wherein
the conduit is connected to a bottom surface of the bottom section.

7. The discharge apparatus according to claim 1, comprising:
a tank that is provided downstream of the pump in the conduit and retains the liquid discharged from the liquid retaining section by the pump, wherein
when an amount of the liquid retained in the tank is equal to or greater than a predetermined amount, the control section notifies that the amount of the liquid retained in the tank is equal to or greater than the predetermined amount.

8. The discharge apparatus according to claim 1, wherein
the engine combusts hydrogen or a natural gas as the combustible gas.

9. The discharge apparatus according to claim 1, wherein
when the value measured by the sensor has exceeded the threshold which is smaller than the value in a case in which the liquid contains only the lubricant and is greater than the value in a case in which the liquid contains only the water, the control section stops the pump.

10. The discharge apparatus according to claim 1, wherein
the sensor is provided at a position in the conduit at which the conduit is covered with the liquid.

11. The discharge apparatus according to claim 2, wherein
when the predetermined length of time which is required for the water to separate from the lubricant and be retained at the bottom section of the liquid retaining section has passed since the engine has been stopped, the control section activates the pump before activation of the engine.

12. The discharge apparatus according to claim 1, wherein
the control section stops the pump in response to the value exceeding the threshold and then activates the engine.
